(19) United States
(12) Patent Application Publication
(10) Pub. No.: US 2026/0003233 A1
(43) Pub. Date: Jan. 1, 2026

(54) LIQUID CRYSTAL LIGHT CONTROL DEVICE AND LIGHTING DEVICE

(71) Applicant: Japan Display Inc., Tokyo (JP)

(72) Inventors: Kojiro IKEDA, Tokyo (JP); Takeo KOITO, Tokyo (JP); Tae KUROKAWA, Tokyo (JP)

(21) Appl. No.: 19/320,279

(22) Filed: Sep. 5, 2025

Related U.S. Application Data
(63) Continuation of application No. PCT/JP2024/008005, filed on Mar. 4, 2024.

(30) Foreign Application Priority Data
Mar. 15, 2023 (JP) 2023-040625

(51) Int. Cl. G02F 1/1343; G02F 1/139

(52) U.S. Cl. CPC G02F 1/1343; G02F 1/1396

(57) ABSTRACT

A liquid crystal light control device includes a first to third liquid crystal cells, the first to third liquid crystal cells being arranged in overlapping order in the light emission direction of light emitted from a light source, each of the first to third liquid crystal cells includes a first electrode formed by first and second strip electrodes arranged on the first substrate, and a second electrode formed by third and fourth strip electrodes arranged on the second substrate, the first and second stripe electrodes extend in a direction intersecting with the direction of the third stripe electrode and fourth stripe electrode, the first and the second stripe electrodes of the first, second, and third liquid crystal cells extend in the same direction, and the third and the fourth stripe electrodes of the first, second, and third liquid crystal cells extend in the same direction.

### CROSS-REFERENCE TO RELATED APPLICATIONS

This application is a Continuation of International Patent Application No. PCT/JP2024/008005, filed on Mar. 4, 2024, which claims the benefit of priority to Japanese Patent Application No. 2023-040625, filed on Mar. 15, 2023, the entire contents of which are incorporated herein by reference.

### FIELD

The present invention relates to a liquid crystal light control device that controls the light distribution of light emitted from a light source by utilizing the electro-optical effect of liquid crystals. The present invention also relates to a lighting device equipped with a liquid crystal light control device.

### BACKGROUND

A liquid crystal light control device that controls the spread of light from a light source by utilizing the property of liquid crystals to change their refractive index in response to an applied voltage is being developed.

The liquid crystal light control device has a structure in which, for example, four liquid crystal cells overlap. It is possible to create a lighting space by incorporating liquid crystal cells into lighting equipment, and to enhance the added value of a product. Incidentally, lighting devices used in various locations need to be miniaturized depending on their application.

### SUMMARY

A liquid crystal light control device in an embodiment according to the present invention includes a first liquid crystal cell, a second liquid crystal cell, and a third liquid crystal cell. Each of the first liquid crystal cell, the second liquid crystal cell, and the third liquid crystal cell includes a first substrate arranged on a light incident side, a second substrate arranged on a light emission side, and a liquid crystal layer between the first substrate and the second substrate. The first liquid crystal cell, the second liquid crystal cell, and the third liquid crystal cell are arranged overlapping each other in the direction of light emission from a light source. Each of the first liquid crystal cell, the second liquid crystal cell, and the third liquid crystal cell includes a first electrode including a first strip electrode and a second strip electrode arranged on the first substrate, and a second electrode including a third strip electrode and a fourth strip electrode arranged on the second substrate. The first stripe electrode and second stripe electrode extend in a direction intersecting with the direction of the third stripe electrode and fourth stripe electrode. The first stripe electrode and the second stripe electrode of the first liquid crystal cell, the first stripe electrode and the second stripe electrode of the second liquid crystal cell, and the first stripe electrode and the second stripe electrode of the third liquid crystal cell extend in the same direction and the third stripe electrode and the fourth stripe electrode of the first liquid crystal cell, the third stripe electrode and the fourth stripe electrode of the second liquid crystal cell, and the third stripe electrode and the fourth stripe electrode of the third liquid crystal cell extend in the same direction.

A lighting device in an embodiment according to the present invention includes a liquid crystal light control device including a first liquid crystal cell, a second liquid crystal cell, and a third liquid crystal cell, and a light source. Each of the first liquid crystal cell, the second liquid crystal cell, and the third liquid crystal cell includes a first substrate arranged on a light incident side, a second substrate arranged on a light emission side, and a liquid crystal layer between the first substrate and the second substrate. The first liquid crystal cell, the second liquid crystal cell, and the third liquid crystal cell are arranged overlapping each other in the direction of light emission from the light source. Each of the first liquid crystal cell, the second liquid crystal cell, and the third liquid crystal cell includes a first electrode including a first strip electrode and a second strip electrode arranged on the first substrate, and a second electrode including a third strip electrode and a fourth strip electrode arranged on the second substrate. The first stripe electrode and second stripe electrode extend in a direction intersecting with the direction of the third stripe electrode and fourth stripe electrode. The first stripe electrode and the second stripe electrode of the first liquid crystal cell, the first stripe electrode and the second stripe electrode of the second liquid crystal cell, and the first stripe electrode and the second stripe electrode of the third liquid crystal cell extend in the same direction and the third stripe electrode and the fourth stripe electrode of the first liquid crystal cell, the third stripe electrode and the fourth stripe electrode of the second liquid crystal cell, and the third stripe electrode and the fourth stripe electrode of the third liquid crystal cell extend in the same direction.

### BRIEF DESCRIPTION OF DRAWINGS

FIG. 1A is a schematic diagram of a liquid crystal light control device according to an embodiment of the present invention.

FIG. 1B is a schematic diagram of a liquid crystal light control device according to an embodiment of the present invention.

FIG. 1C is a schematic diagram of a liquid crystal light control device according to an embodiment of the present invention.

FIG. 1D is a schematic diagram of a liquid crystal light control device according to an embodiment of the present invention.

FIG. 1E is a schematic diagram of a liquid crystal light control device according to an embodiment of the present invention.

FIG. 1F is a schematic diagram of a liquid crystal light control device according to an embodiment of the present invention.

FIG. 1G is a schematic diagram of a liquid crystal light control device according to an embodiment of the present invention.

FIG. 2 is a graph showing the light distribution characteristics of a liquid crystal light control device according to an embodiment of the present invention.

FIG. 3 is a graph showing the light distribution characteristics of a liquid crystal light control device according to an embodiment of the present invention.

FIG. 4 is a diagram showing a configuration of liquid crystal light control device according to an embodiment of the present invention.

FIG. 5 is a graph showing the light distribution characteristics of a liquid crystal light control device according to an embodiment of the present invention.

FIG. 6 is a diagram showing a configuration of lighting device including a liquid crystal light control device according to an embodiment of the present invention.

FIG. 7 is a perspective view showing the structure of a liquid crystal cell configuring a liquid crystal light control device according to an embodiment of the present invention.

FIG. 8A is a plan view of an electrode of a liquid crystal cell configuring a liquid crystal light control device according to an embodiment of the present invention.

FIG. 8B is a plan view of an electrode of a liquid crystal cell configuring a liquid crystal light control device according to an embodiment of the present invention.

FIG. 9A is a diagram for explaining the operation of a liquid crystal cell configuring liquid crystal light control device according to an embodiment of the present invention and shows the alignment state of liquid crystal molecules when a voltage is applied.

FIG. 9B is a diagram for explaining the operation of a liquid crystal cell configuring liquid crystal light control device according to an embodiment of the present invention and shows the alignment state of liquid crystal molecules when a voltage is applied.

FIG. 10 is a diagram showing a relationship between a voltage applied to a liquid crystal cell configuring a liquid crystal light control device according to an embodiment of the present invention and light distribution.

FIG. 11A is a diagram showing a waveform of a control signal applied to a liquid crystal cell configuring a liquid crystal light control device according to an embodiment of the present invention.

FIG. 11B is a diagram showing a waveform of a control signal applied to a liquid crystal cell configuring a liquid crystal light control device according to an embodiment of the present invention.

### DESCRIPTION OF EMBODIMENTS

Hereinafter, embodiments of the present invention are described with reference to the drawings. However, the present invention can be implemented in many different aspects and should not be construed as being limited to the description of the following embodiments. For the sake of clarifying the explanation, the drawings may be expressed schematically with respect to the width, thickness, shape, and the like of each part compared to the actual aspect, but this is only an example and does not limit the interpretation of the present invention. In this specification and each drawing, elements similar to those described previously with respect to previous drawings may be given the same reference sign (or a number followed by a, b, etc.) and a detailed description may be omitted as appropriate. The terms “first” and “second” appended to each element are convenient terms used to distinguish them and have no further meaning except as otherwise explained.

As used herein, where a member or region is “on” (or “below”) another member or region, this includes cases where it is not only directly on (or just under) the other member or region but also above (or below) the other member or region, unless otherwise specified. That is, it includes the case where another component is included in between above (or below) other members or regions.

The term “optical rotation” as used herein refers to a phenomenon in which a linearly polarized component rotates its polarization axis as it passes through the liquid crystal layer.

The term “alignment direction” of an alignment film herein refers to the direction in which the liquid crystal molecules are aligned on the alignment film by a treatment (for example, rubbing treatment) that imparts an alignment restricting force on the alignment film. When the treatment performed on the alignment film is a rubbing treatment, the alignment direction of the alignment film is usually the rubbing direction.

The “direction of extension” of a strip electrode herein refers to the direction in which the long side of a pattern having a short side (width) and a long side (length) extends when the strip pattern is viewed in a plan view.

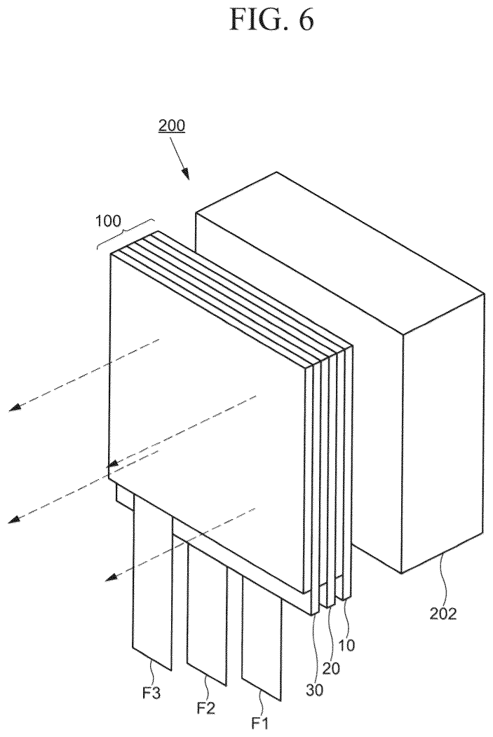

FIG. 6 is a perspective view of a lighting device 200 according to an embodiment of the present invention. The lighting device 200 includes a liquid crystal light control device 100 and a light source 202. The liquid crystal light control device 100 includes a structure in which a first liquid crystal cell 10, a second liquid crystal cell 20, and a third liquid crystal cell 30 are arranged from the side of the light source 202. A transparent adhesive layer (not shown) is arranged between the first liquid crystal cell 10 and the second liquid crystal cell 20 and between the second liquid crystal cell 20 and the third liquid crystal cell 30. The liquid crystal light control device 100 includes a structure in which the liquid crystal cells arranged adjacent to each other in front and rear are bonded by the transparent adhesive layer.

The liquid crystal light control device 100 is connected to a control circuit (not shown) and its operation is controlled. The liquid crystal light control device 100 and the control circuit are connected by a flexible wiring board. Specifically, the first flexible wiring board F1 is connected to the first liquid crystal cell 10, the second flexible wiring board F2 is connected to the second liquid crystal cell 20, and the third flexible wiring board F3 is connected to the third liquid crystal cell 30.

The lighting device 200 shown in FIG. 6 is configured such that light emitted from the light source 202 is emitted to the front side of the drawing through the liquid crystal light control device 100. The light source 202 includes a white light source, and optical elements such as a lens may be arranged between the white light source and the liquid crystal light control device 100 as required. The white light source is a light source which emits light close to natural light, and may be a light source which emits dimmed light, such as natural white light or light bulb color. The light source 202 preferably includes a light source having a narrow light distribution range and preferably has a structure such as an LED light source combined with a reflector and a lens.

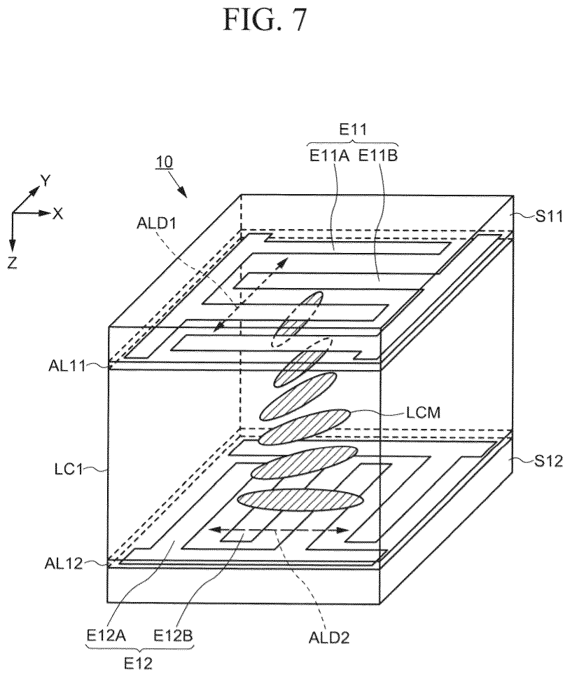

FIG. 7 is a perspective view showing the liquid crystal cell 10. The liquid crystal cell 10 includes a first substrate S11, a second substrate S12, a first electrode E11, a second electrode E12, a first alignment film AL11, a second alignment film AL12, and a first liquid crystal layer LC1. The first electrode E11 is arranged on the first substrate S11, and the second electrode E12 is arranged on the second substrate S12. The first alignment film AL11 is arranged on the first substrate S11 to cover the first electrode E11, and the second alignment film AL12 is arranged on the second substrate S12 to cover the second electrode E12. The liquid crystal layer LC1 is arranged between the first substrate S11 and the second substrate S12. The first electrode E11 and the second electrode E12 are arranged to face each other across the first liquid crystal layer LC1.

The first electrode E11 includes a first strip electrode E11A and a second strip electrode E11B having a strip pattern (or a comb-shaped pattern). The second electrode E12 includes a third strip electrode E12A and a fourth strip electrode E12B having a strip pattern (or a comb-shaped pattern). The first strip electrode E11A and the second strip electrode E11B are alternately arranged on the insulating surface of the first substrate S11, and the third strip electrode E12A and the fourth strip electrode E12B are alternately arranged on the insulating surface of the second substrate S12.

FIG. 7 shows the X, Y and Z-axis directions for illustration. In the liquid crystal cell 10, the direction of extension of the first strip electrode E11A and the second strip electrode E11B is parallel to the X-axis direction, and the direction of extension of the third strip electrode E12A and the fourth strip electrode E12B is parallel to the Y-axis direction. That is, the third strip electrode E12A and the fourth strip electrode E12B are arranged to intersect the first strip electrode E11A and the second strip electrode E11B. The direction of extension of the first strip electrode E11A and the second strip electrode E11B intersects with the direction of extension of the third strip electrode E12A and the fourth strip electrode E12B, for example, within a range of 90±10 degrees, and preferably orthogonally (90 degrees).

An extending direction of the strip electrodes configuring the first electrode E11 and the second electrode E12 may be inclined by ±10 degrees with respect to the X-axis and the Y-axis. The strip electrode may be partially bent while extending in a predetermined direction. In this case, the strip electrode has a plurality of extension directions in the longitudinal direction, but each extension direction may be inclined by ±10 degrees with respect to the X-axis or the Y-axis. Similarly, the strip electrode may be partially curved while extending in a predetermined direction. In this case, the tangential direction at each position of the strip electrode is regarded as the extending direction, and each extending direction may be inclined by ±10 degrees with respect to the X-axis or the Y-axis.

An alignment direction ALD1 of the first alignment film AL11 is arranged in a direction (Y-axis direction) intersecting the direction of extension of the first strip electrode E11A and the second strip electrode E11B, and an alignment direction ALD2 of the second alignment film AL12 is arranged in a direction (X-axis direction) intersecting the direction of extension of the third strip electrode E12A and the fourth strip electrode E12B. The angle between the direction of extension of the first strip electrode E11A and the second strip electrode E11B and the alignment direction ALD1, and the angle between the direction of extension of the third strip electrode E12A and the fourth strip electrode E12B and the alignment direction ALD2 can be set within a range of 90±10 degrees.

The distance (Hereinafter, also referred to as “cell gap”.) between the first substrate S11 and the second substrate S12 can be appropriately set in the range of 10 μm to 100 μm, preferably 15 μm to 55 μm. The film thicknesses of the first electrode E11, the second electrode E12, and the first alignment film AL11 and the second alignment film AL12 are negligibly small compared with the distance between the first substrate S11 and the second substrate S12. Therefore, the distance between the first substrate S11 and the second substrate S12 can be regarded as the thickness of the first liquid crystal layer LC1. Although not shown in FIG. 7, spacers may be arranged between the first substrate S11 and the second substrate S12 for maintaining a constant distance.

The first liquid crystal layer LC1 is, for example, a twisted nematic liquid crystal (TN liquid crystal). When a voltage is not applied to the first electrode E11 and the second electrode E12, the first liquid crystal layer LC1, which is affected by the alignment restricting force of the first alignment film AL11 and the second alignment film AL12, aligns the long axis direction of the liquid crystal molecules LCM parallel to the alignment direction ALD1 and ALD2 of the alignment films. Since the alignment direction ALD1 of the first alignment film AL11 and the alignment direction ALD2 of the second alignment film AL12 cross (perpendicular to each other), the alignment direction of the liquid crystal molecules LCM gradually changes such that the long axis direction is twisted by 90 degrees from the first substrate S11 to the second substrate S12.

When a voltage is applied to the initial alignment state of the liquid crystal molecules LCM shown in FIG. 7 so that a potential difference is generated between the first strip electrode E11A and the second strip electrode E11B, the alignment state of the liquid crystal molecules LCM on the first substrate S11 side is changed. The alignment state of the liquid crystal molecules LCM on the second substrate S12 side is changed by applying a voltage such that a potential difference is generated between the third strip electrode E12A and the fourth strip electrode E12B.

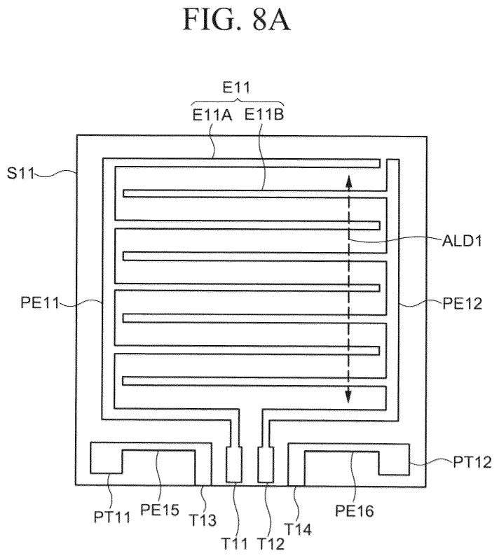

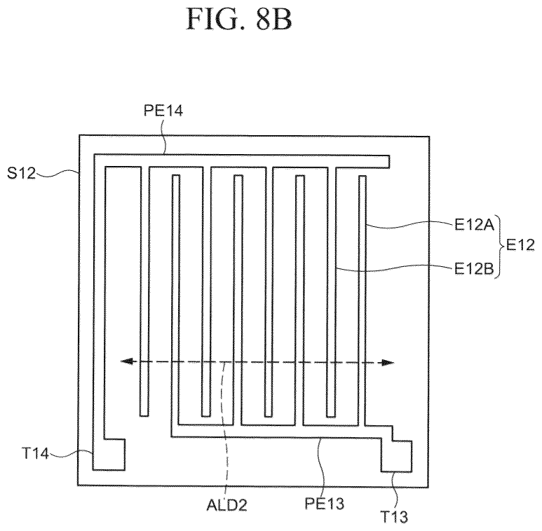

FIG. 8A is a plan view of the first substrate S11, and FIG. 8B is a plan view of the second substrate S12. As shown in FIG. 8A and FIG. 8B, the first electrode E11 includes a plurality of first strip electrodes E11A and a plurality of second strip electrodes E11B alternately arranged at predetermined distances, and the second electrode E12 includes a plurality of third strip electrodes E12A and a plurality of fourth strip electrodes E12B alternately arranged at predetermined distances.

As shown in FIG. 8A, each of the plurality of first strip electrodes E11A is connected to a first power supply line PE11, and each of the plurality of second strip electrodes E11B is connected to a second power supply line PE12. The first power supply line PE11 is connected to a first connecting terminal T11, and the second power supply line PE12 is connected to a second connecting terminal T12. The first connecting terminal T11 and the second connecting terminal T12 are arranged along one side of the end of the first substrate S11. A third connecting terminal T13 is arranged adjacent to the first connecting terminal T11, and a fourth connecting terminal T14 is arranged adjacent to the second connecting terminal T12 on the first substrate S11. The third connecting terminal T13 is connected to a fifth power supply line PE15. The fifth power supply line PE15 is connected to a first power supply terminal PT11 arranged at a predetermined position in the surface of the first substrate S11. The fourth connecting terminal T14 is connected to a sixth power supply line PE16. The sixth power supply line PE16 is connected to a second connecting terminal PT12 arranged at a predetermined position in the surface of the first substrate S11.

The plurality of first strip electrodes E11A is connected to the first power supply line PE11 so that the same voltage is applied. The plurality of second strip electrodes E11B is connected to the second power supply line PE12 so that the same voltage is applied. When different voltages are applied to the first connecting terminal T11 and the second connecting terminal T12, an electric field is generated between the plurality of first strip electrodes E11A and the plurality of second strip electrodes E11B.

As shown in FIG. 8B, each of the plurality of third strip electrodes E12A is connected to a third power supply line PE13, and each of the plurality of fourth strip electrodes E12B is connected to a fourth power supply line PE14. The third power supply line PE13 is connected to the third connecting terminal T13, and the fourth power supply line PE14 is connected to the fourth connecting terminal T14. A third power supply terminal PT13 is arranged at a position corresponding to the first power supply terminal PT11 of the first substrate S11, and a fourth power supply terminal PT14 is arranged at a position corresponding to the second power supply terminal PT12 of the first substrate S11. The third power supply terminal PT13 and the first power supply terminal PT11, and the fourth power supply terminal PT14 and the second power supply terminal PT12 are electrically connected. A conductive paste is used for electrical connection between these power supply terminals. For example, silver paste is used as the conductive paste.

When different voltages are applied to the third connecting terminal T13 and the fourth connecting terminal T14, an electric field is generated between the plurality of third strip electrodes E12A and the plurality of fourth strip electrodes E12B. That is, a transverse electric field is generated by the plurality of third strip electrodes E12A and the plurality of fourth strip electrodes E12B.

The first substrate S11 and the second substrate S12 are light-transmitting substrates, for example, glass substrates and resin substrates. The first electrode E11 and the second electrode E12 are transparent electrodes formed of a transparent conductive material such as indium tin oxide (ITO) or indium zinc oxide (IZO). The power supply line (first power supply line PE11, second power supply line PE12, third power supply line PE13, fourth power supply PE14) and the connecting terminal (first connecting terminal T11, second connecting terminal T12, third connecting terminal T13, fourth connecting terminal T14) are formed of a metal material such as aluminum, titanium, molybdenum, and tungsten. The power supply lines (the first power supply line PE11, the second power supply line PE12, the third power supply line PE13, and the fourth power supply line PE14) may be formed of the same transparent conductive film as the first electrode E11 and the second electrode E12. Either one or both of the first electrode E11 and the second electrode E12 may be formed of a metal material or a transparent conductive film laminated with a metal material.

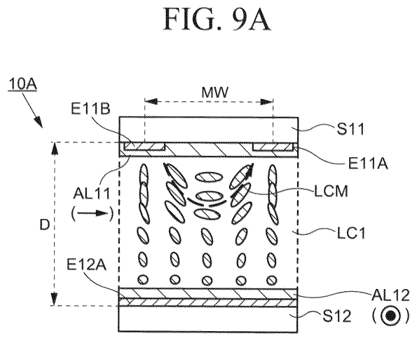

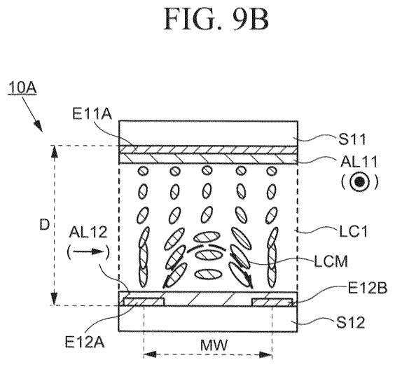

FIG. 9A shows a partial cross-sectional view of the liquid crystal cell 10 viewed from a direction perpendicular to the direction in which the third strip electrode E12A extends, and FIG. 9B shows a partial cross-sectional view of the liquid crystal cell 10 as viewed from a direction perpendicular to the direction in which the first strip electrode E11A extends. The fact that the alignment direction ALD1 of the first alignment film AL11 is different from the alignment direction ALD2 of the second alignment film AL12 is indicated by symbols in FIG. 9A and FIG. 9B.

As shown in FIG. 9A and FIG. 9B, the first substrate S11 and the second substrate S12 are arranged to face each other at a distance D. As described above, the distance D is a distance between substrates, which substantially corresponds to the thickness of the first liquid crystal layer LC1. FIG. 9A and FIG. 9B show center-to-center distances MW between the first strip electrode E11A and the second strip electrode E11B, and between the third strip electrode E12A and the fourth strip electrode E12B.

The distance D corresponding to the thickness of the first liquid crystal layer LC1 is preferably equal to or larger than the center-to-center distance MW of the strip electrodes (D≥MW). That is, the distance D is preferably one or more times as long as the center-to-center distance MW. For example, the distance D corresponding to the thickness of the first liquid crystal layer LC1 is preferably at least twice as large as the center-to-center distance MW of the strip electrodes. For example, when the center-to-center distance MW is 16 μm, the distance D corresponding to the thickness of the first liquid crystal layer LC1 is preferably 16 μm or more, for example, 20 μm is preferable, and 30 μm is more preferable.

Since the center-to-center distance MW of the strip electrodes and the distance D corresponding to the thickness of the first liquid crystal layer LC1 have such a relationship, interference between an electric field generated between the first strip electrode E11A and the second strip electrode E11B and an electric field generated between the third strip electrode E12A and the fourth strip electrode E12B is prevented.

It is known that the refractive index of liquid crystals changes depending on the alignment state. When the first liquid crystal layer LC1 is in an off (OFF) state in which an electric field is not applied, the long axis direction of the liquid crystal molecules LCM is aligned horizontally with the surface of the substrate and is aligned in a state twisted by 90 degrees from the first substrate S11 side to the second substrate S12 side. At this time, the first liquid crystal layer LC1 has a uniform refractive index distribution. When light is incident on the liquid crystal cell 10, the polarized component of the incident light changes its direction due to the twisting of the liquid crystal molecules LCM. In this case, the incident light passes through the first liquid crystal layer LC1 without being refracted (or scattered) while being optically rotated.

On the other hand, as shown in FIG. 9A, when an electric field is generated between the first strip electrode E11A and the second strip electrode E11B, the long axis of the liquid crystal molecules LCM is aligned along the electric field (when the liquid crystal has positive dielectric anisotropy). As a result, as shown in FIG. 9A, the first liquid crystal layer LC1 has a region where liquid crystal molecules LCM rise above the first strip electrode E11A and the second strip electrode E11B, and a region where the liquid crystal molecules LCM are aligned obliquely along the electric field distribution between the first strip electrode E11A and the second strip electrode E11B, and a region where the initial alignment state is maintained in a region away from the first substrate S11.

Similarly, as shown in FIG. 9B, when the third strip electrode E12A and the fourth strip electrode E12B are turned on (ON) so that an electric field is generated between them, the first liquid crystal layer LC1 has a region where liquid crystal molecules LCM rise above the third strip electrode E12A and the fourth strip electrode E12B, a region where the liquid crystal molecules LCM are aligned obliquely along the electric field distribution between the third strip electrode E12A and the fourth strip electrode E12B, and a region where the initial alignment state is maintained in the region away from the second substrate S12.

Hereinafter, the electric field generated by the first strip electrode E11A and the second strip electrode E11B, and the third strip electrode E12A and the fourth strip electrode E12B is also referred to as a “lateral electric field.”

As shown in FIG. 9A and FIG. 9B, when an electric field is generated between the first strip electrode E11A and the second strip electrode E11B, and between the third strip electrode E12A and the fourth strip electrode E12B, a region is formed where the liquid crystal molecules LCM are aligned in a convex arc shape with the long axis of the liquid crystal molecules in the direction of the electric field. That is, as shown in FIG. 9A, when the direction of the initial alignment of the liquid crystal molecules LCM and the direction of the lateral electric field generated between the first strip electrode E11A and the second strip electrode E11B are the same, the liquid crystal molecules LCM are aligned by tilting in the normal direction with respect to the surface of the first substrate S11 in accordance with the intensity distribution of the electric field.

As shown in FIG. 9A, since the distance D corresponding to the thickness of the first liquid crystal layer LC1 is sufficiently large, the effect of the electric field on the alignment of the liquid crystal molecules on the second substrate S12 side is extremely small, and the alignment state of the liquid crystal molecules LCM on the second substrate S12 side is hardly affected by the electric field generated on the first substrate S11 side. The same is true for FIG. 9B, the alignment state of the liquid crystal molecules LCM on the second substrate S12 side changes under the influence of the electric field generated by the third strip electrode E12A and the fourth strip electrode E12B, but the liquid crystal molecules LCM on the first substrate S11 side are hardly affected by this electric field.

By forming the lateral electric field by the strip electrodes, the convex arc-shaped dielectric constant distribution is formed in the first liquid crystal layer LC1. Among the light incident on the first liquid crystal layer LC1, the polarized component parallel to the initial alignment direction of the liquid crystal molecules LCM is diffused radially by the dielectric constant distribution. As shown in FIG. 9A and FIG. 9B, the direction of the initial alignment of the liquid crystal molecules LCM intersects (is orthogonal) between the first substrate S11 side and the second substrate S12 side, so that light can be diffused in different directions on the first substrate S11 side and the second substrate S12 side.

In this way, when light passes through the liquid crystal cell 10, some of the polarized components are transmitted while diffusing depending on the formation state of the electric field in the first liquid crystal layer LC1, and the remaining polarized components are transmitted as they are through the first liquid crystal layer LC1.

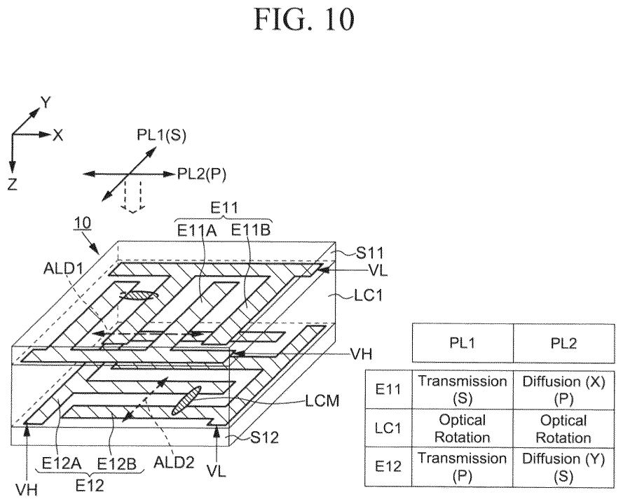

FIG. 10 shows that the first strip electrode E11A and the second strip electrode E11B of the first electrode E11 extend in the X-axis direction, and the third strip electrode E12A and the fourth strip electrode E12B of the second electrode E12 extend in the Y-axis direction in the liquid crystal cell 10. FIG. 10 also shows a state in which a voltage VH is applied to the first strip electrode E11A, a voltage VL (VL<VH) is applied to the second strip electrode E11B, the voltage VH is applied to the third strip electrode E12A, and the voltage VL (VL<VH) is applied to the fourth strip electrode E12B. With such voltage application conditions, a lateral electric field is generated in the Y-axis direction on the first substrate S11 side, and a lateral electric field is generated in the X-axis direction on the second substrate S12 side.

FIG. 10 shows that the light emitted from the light source has a first polarized component PL1 and a second polarized component PL2, and that the first polarized component PL1 corresponds to an S-wave and the second polarized component PL2 corresponds to a P-wave. Here, the S-wave has an amplitude in the Y-axis direction, and the P-wave has an amplitude in the X-axis direction. As shown in the table inserted in FIG. 10, light incident on the liquid crystal cell 10 undergoes optical effects such as transmission, optical rotation, and diffusion. “Transmission” in the table refers to transmission without any change in the polarization axis of a predetermined polarized component or in the light distribution state. As mentioned above, “optical rotation” refers to the phenomenon in which the polarization axis of the linearly polarized component rotates when it passes through the liquid crystal layer. Then, “diffusion (X)” indicates that the polarized component diffuses in the X-axis direction, and “diffusion (Y)” indicates that the polarized component diffuses in the Y-axis direction. The notation shown in the table shown in FIG. 10 is the same in each of the embodiments described below.

FIG. 10 shows a situation in which light containing a first polarized component PL1 (S-wave) and a second polarized component PL2 (P-wave) is incident on the liquid crystal cell 10 and is emitted from the second substrate S12.

Although not shown, the alignment direction ALD1 of the first alignment film AL1 is parallel to the X-axis, the alignment direction ALD2 of the second alignment film AL2 is parallel to the Y-axis, and the alignment direction of the liquid crystal molecules LCM of the first liquid crystal layer LC1 is affected by the alignment restricting force of these alignment films. Therefore, the long axis of the liquid crystal molecules LCM on the first substrate S11 side is in the Y-axis direction, and the long axis of the liquid crystal molecules LCM on the second substrate S12 side is in the X-axis direction.

Among the light incident from the first substrate S11, the light of the first polarized component PL1 is the S-wave, and since the polarization direction intersects with the long axis direction of the liquid crystal molecules LCM on the first electrode E11 side, it is transmitted without being affected by the arc-shaped refractive index distribution formed by the alignment of the liquid crystal molecules LCM. The first polarized component PL1 is optically rotated, for example by 90 degrees, and transitions to the P-wave as it passes through the first liquid crystal layer LC1 from the first substrate S11 side to the second substrate S12 side. Since the first polarized component PL1 is the P-wave, the polarization direction intersects with the long axis direction of the liquid crystal molecules LCM on the second electrode E12 side, and it passes through without being affected by the arc-shaped refractive index distribution formed by the alignment of the liquid crystal molecules LCM. On the other hand, the second polarized component PL2 is the P-wave, and since the polarization direction is parallel to the long axis direction of the liquid crystal molecules LCM on the first electrode E11 side, it diffuses in the X-axis direction due to the influence of the arc-shaped refractive index distribution formed by the alignment of the liquid crystal molecules LCM. The second polarized component PL2 is optically rotated by 90 degrees by passing through the first liquid crystal layer LC1 from the first substrate S11 side to the second substrate S12 side, and transitions to the S-wave. Since the polarization direction of the second polarized component PL2 is parallel to the long axis direction of the liquid crystal molecules LCM on the second electrode E12 side, it diffuses in the Y-axis direction due to the influence of the arc-shaped refractive index distribution formed by the alignment of the liquid crystal molecules LCM.

As described above, when light is incident on the liquid crystal cell 10 shown in FIG. 10, the first polarized component PL1 (S-wave) is not diffused, and is optically rotated by the first liquid crystal layer LC1 and transitions to the P-wave, the second polarized component PL2 (P-wave) is diffused once in each of the X-axis direction and the Y-axis direction, and is optically rotated by the first liquid crystal layer LC1 and transitions to the S-wave.

The liquid crystal light control device 100 according to the present embodiment can distribute light emitted from the light source into various shapes by stacking three liquid crystal cells having the same configuration as the liquid crystal cell 10 and varying the voltage applied to each electrode. The details are described below.

### First Embodiment

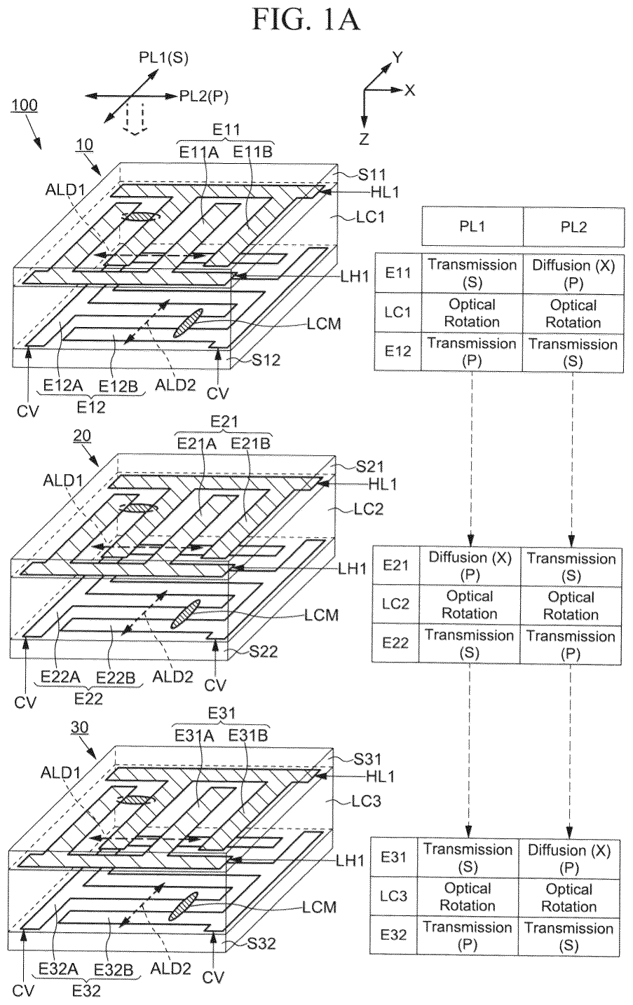

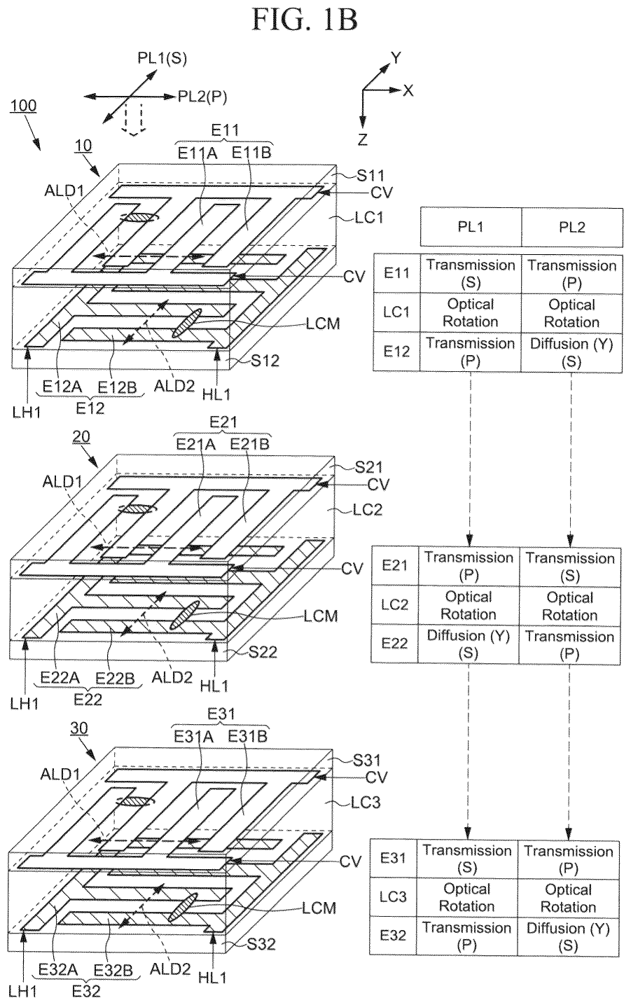

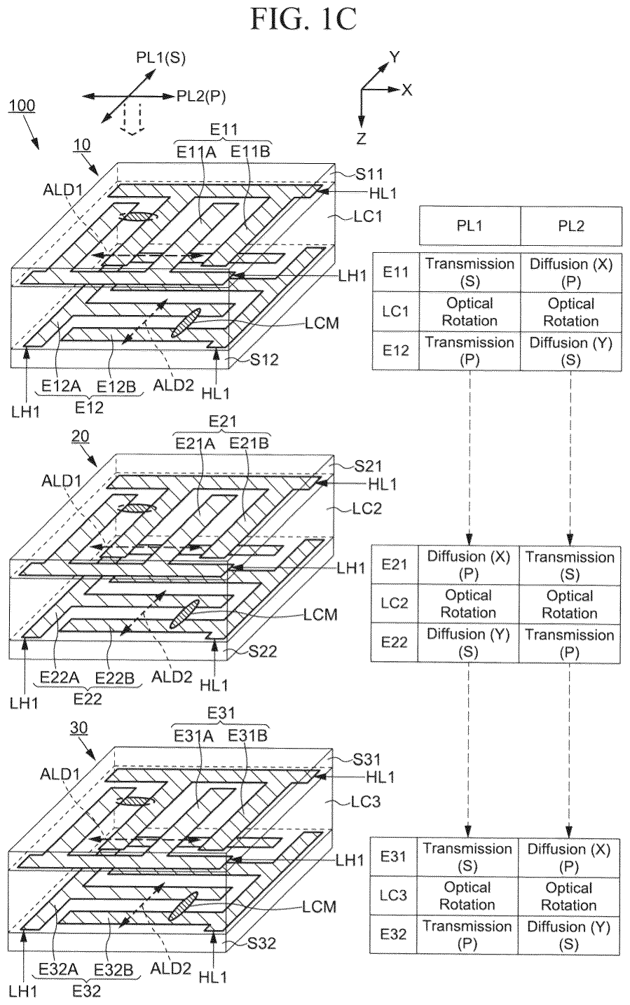

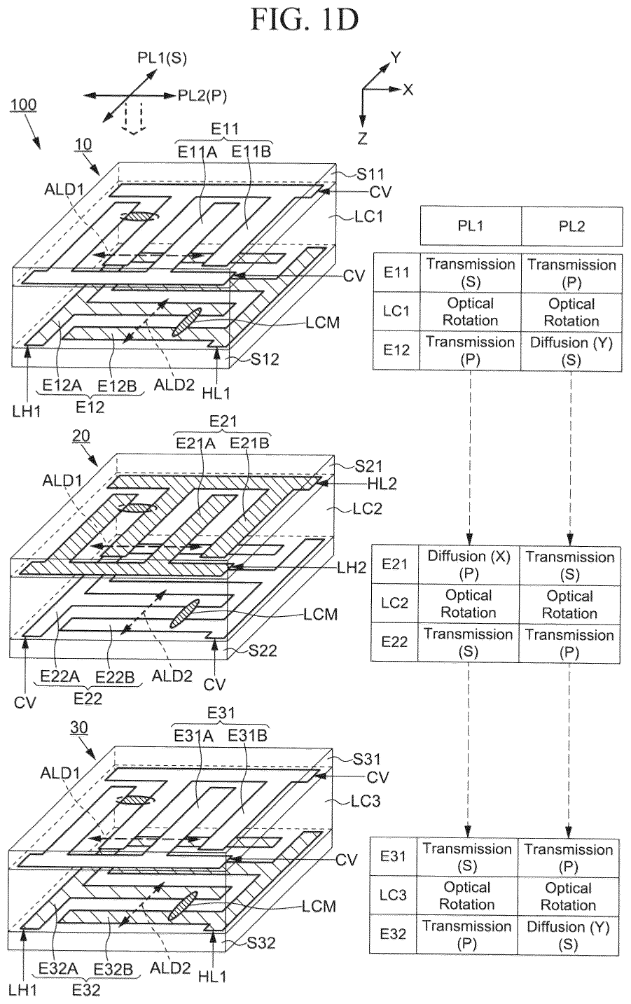

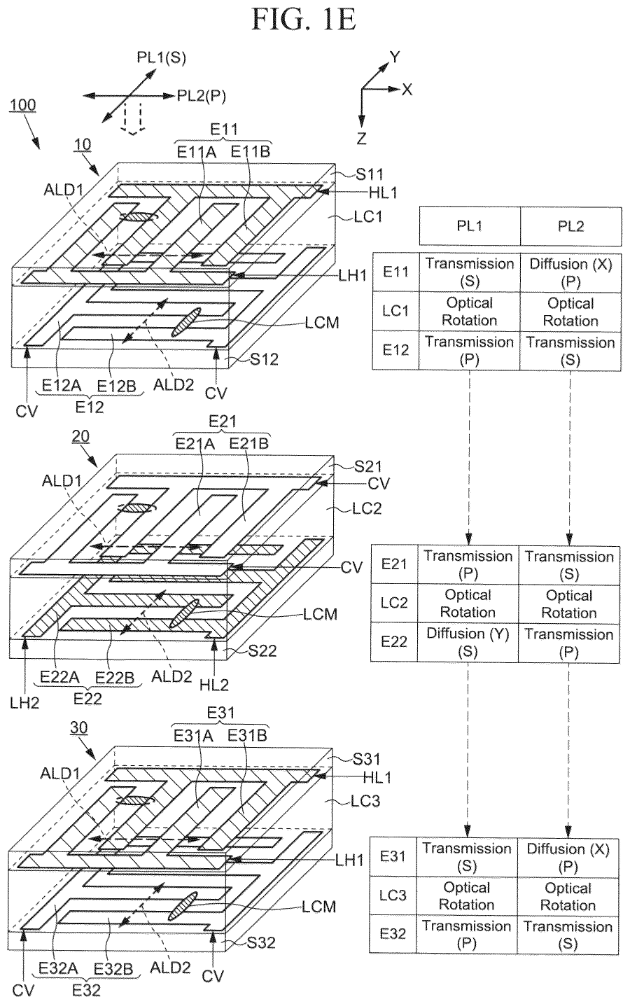

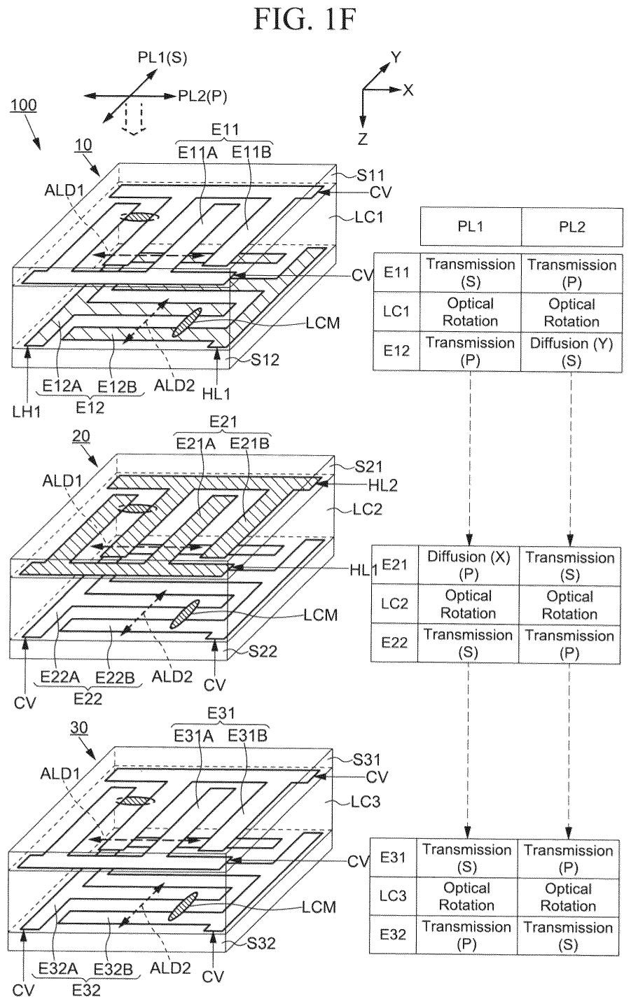

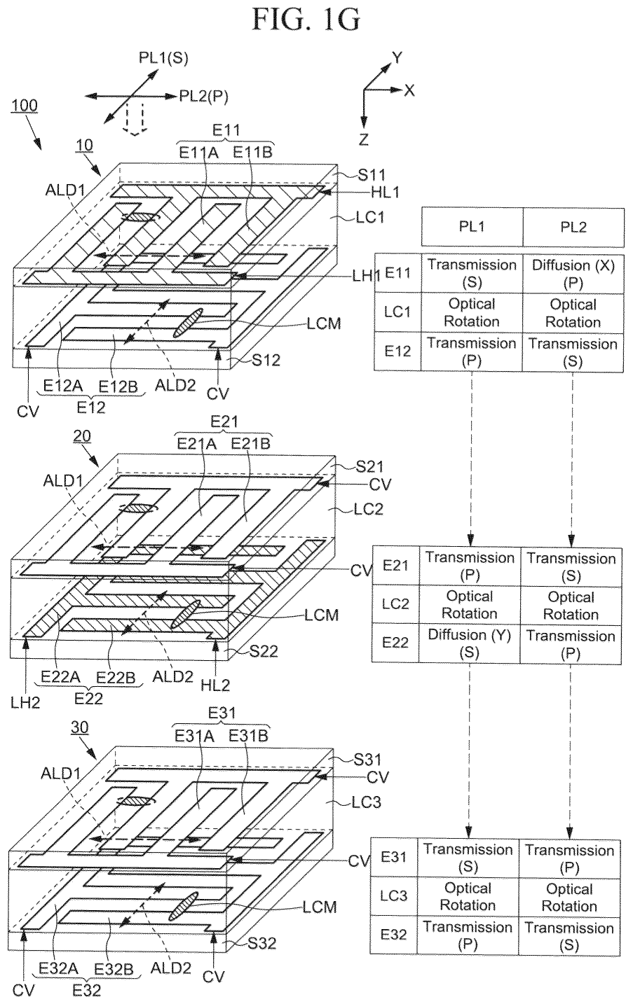

FIG. 1A shows a configuration of a liquid crystal light control device 100 according to the present embodiment. The liquid crystal light control device 100 has a structure in which the first liquid crystal cell 10, the second liquid crystal cell 20, and the third liquid crystal cell 30 are stacked in the Z-axis direction. Although the light source is not shown in FIG. 1A, light emitted from the light source passes through the first liquid crystal cell 10, the second liquid crystal cell 20, and the third liquid crystal cell 30 in that order and is emitted into the illumination space. The first liquid crystal cell 10, the second liquid crystal cell 20, and the third liquid crystal cell 30 each include a first substrate S11, S21, and S31 arranged on the light incident side, and a second substrate S12, S22, and S32 arranged on the light emitted side.

FIG. 1A shows, for explanation, each liquid crystal cell arranged separately, but the actual liquid crystal light control device 100 has a structure in which each liquid crystal cell is bonded with the transparent adhesive. For simplicity, the alignment film is omitted in FIG. 1A. These notes apply to other drawings shown in this embodiment and other drawings shown in other embodiments.

The first liquid crystal cell 10, the second liquid crystal cell 20, and the third liquid crystal cell 30 have the same configuration as the liquid crystal cell 10 shown in FIG. 10. The first liquid crystal cell 10 includes the first electrode E11 arranged on the first substrate S11 and the second electrode E12 arranged on the second substrate S12. The second liquid crystal cell 20 includes a first electrode E21 arranged on the first substrate S21 and a second electrode E22 arranged on the second substrate S22. The third liquid crystal cell 30 includes a first electrode E31 arranged on the first substrate S31 and a second electrode E32 arranged on the second substrate S32. The first electrodes E11, E21, and E31 are configured by first strip electrodes E11A, E21A, and E31A and second strip electrodes E11B, E21B, and E31B, and these strip electrodes extend in the Y-axis direction. The second electrodes E12, E22, and E32 are configured by third strip electrodes E12A, E22A, and E32A and fourth strip electrodes E12B, E22B, and E32B, and these strip electrodes extend in the X-axis direction. In the first liquid crystal cell 10, the second liquid crystal cell 20, and the third liquid crystal cell 30, the first strip electrodes E11A, E21A, and E31A and the second strip electrodes E11B, E21B, and E31B extend in the same direction, and the third strip electrodes E12A, E22A, and E32A and the fourth strip electrodes E12B, E22B, and E32B extend in the same direction.

Although not shown in the diagram, in the first liquid crystal cell 10, the second liquid crystal cell 20, and the third liquid crystal cell 30, a first alignment film is arranged on the side of the first substrate S11, S21, and S31, and a second alignment film is arranged on the side of the second substrate S12, S22, and S32. The alignment direction ALD1 of the first alignment film is parallel to the X-axis, and the alignment direction ALD2 of the second alignment film is parallel to the Y-axis. The alignment direction ALD1 of the first alignment film and the alignment direction ALD2 of the second alignment film are arranged to intersect (preferably orthogonally).

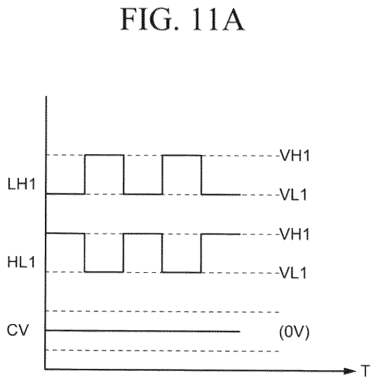

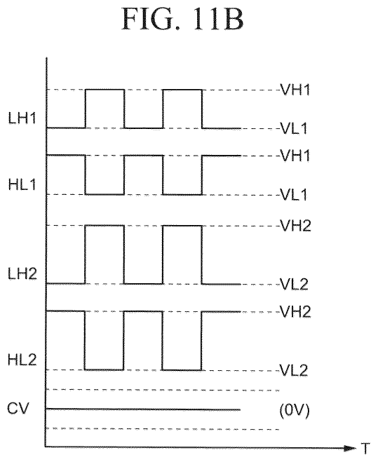

The first liquid crystal cell 10, the second liquid crystal cell 20, and the third liquid crystal cell 30 are driven by control signals LH1, HL1, and CV. FIG. 11A shows waveforms of the control signals LH1, HL1, and CV. The control signal LH1 is a signal whose voltage level changes from VL1 to VH1 and from VH1 to VL1, and the control signal HL1 is a signal whose voltage level periodically changes from VH1 to VL1 and from VL1 to VH1. The low-level voltage VL is, for example, 0 V or −15 V, and the high-level voltage Vh1 is, for example, 30 V (when VL=0 V) or 15 V (when VL=−15 V). The control signals LH1 and HL1 are synchronized, such that when the control signal LH1 is at the level of VH1, the control signal HL1 is at the level of VL1, and when the control signal LH1 changes to the level of VL1, the control signal HL1 changes to the level of VH1. The period of control signals LH1 and HL1 is approximately 15 to 100 Hz. On the other hand, control signal CV is a constant voltage signal, such as a voltage signal at the midpoint between VL1 and VH1 or at 0 V.

FIG. 1A shows a state in which the control signal LH1 is applied to the first strip electrode E11A of the first liquid crystal cell 10, the control signal HL1 is applied to the second strip electrode E11B, the control signal CV is applied to the third strip electrode E12A and the fourth strip electrode E12B, the control signal LH1 is applied to the first strip electrode E21A of the second liquid crystal cell 20, the control signal HL1 is applied to the second strip electrode E21B, the control signal CV is applied to the third strip electrode E22A and the fourth strip electrode E22B, the control signal LH1 is applied to the first strip electrode E31A of the third liquid crystal cell 30, the control signal HL1 is applied to the second strip electrode E31B, and the control signal CV is applied to the third strip electrode E32A and the fourth strip electrode E32B.

As shown in the table inserted in FIG. 1A, the first polarized component PL1 (S-wave) of the light emitted from the light source is optically rotated by the first liquid crystal cell 10 and transitions to the P-wave, is diffused in the X-axis direction at the first electrode E21 of the second liquid crystal cell 20, is optically rotated by the second liquid crystal layer LC2 and transitions to the S-wave, and is optically rotated by the third liquid crystal cell 30 and transitions to the P-wave before being emitted. The second polarized component PL2 (P-wave) is diffused in the X-axis direction at the first electrode E11 of the first liquid crystal cell 10, is optically rotated by the first liquid crystal layer LC1 to transition to the S-wave, optically rotated by the second liquid crystal cell 20 to transition to the P-wave, is diffuses in the X-axis direction at the first electrode E31 of the third liquid crystal cell 30, is optically rotated by the third liquid crystal layer LC3, transitions to the S-wave, and is emitted.

In this embodiment, focusing on the first liquid crystal cell 10, the first electrode E11 of the first substrate S11 and the second electrode E12 of the second substrate S12 are orthogonal to each other, which means that they optically rotate at an angle of substantially 90 degrees with respect to the above optical rotation. When these electrodes intersect at an angle smaller than 90 degrees, the angle of optical rotation becomes smaller than 90 degrees. That is, the angle of the above “optical rotation” is determined based on the intersection angle of the first electrode E11 and the second electrode E12, and may include not only optical rotation at 90 degrees but also optical rotation at angles smaller than 90 degrees. In other words, the angle of the above “optical rotation” can be said to be determined based on the intersection angle between the alignment direction ALD1 of the alignment film on the first substrate E11 side and the alignment direction ALD2 of the alignment film on the second substrate E12 side, and depending on the intersection angle between the alignment directions of the alignment films, optical rotation at an angle of 90 degrees is possible, and optical rotation at an angle smaller than 90 degrees is also possible. The same applies to the second liquid crystal cell 20 and the third liquid crystal cell 30. The same applies to the other embodiments described below.

Therefore, the liquid crystal light control device 100, under the control signal application conditions shown in FIG. 1A, diffuses the first polarized component PL1 once in the X-axis direction and the second polarized component PL2 twice in the X-axis direction while optically rotating the first polarized component PL1 and the second polarized component PL2, and then emits the light. That is, the voltage application conditions shown in FIG. 1A can spread the light distribution state of the light emitted from the light source in the X-axis direction. Such a light distribution pattern can be called line light distribution.

FIG. 1B shows that the control signal CV is applied to the first strip electrode E11A and the second strip electrode E11B of the first liquid crystal cell 10, the control signal LH1 is applied to the third strip electrode E12A, and the control signal HL1 is applied to the fourth strip electrode E12B, the control signal CV is applied to the first strip electrode E21A and the second strip electrode E21B of the second liquid crystal cell 20, the control signal LH1 is applied to the third strip electrode E22A, and the control signal HL1 is applied to the fourth strip electrode E22B, the control signal CV is applied to the first strip electrode E31A and the second strip electrode E31B of the third liquid crystal cell 30, the control signal LH1 is applied to the third strip electrode E32A, and the control signal HL1 is applied to the fourth strip electrode E32B.

As shown in the table inserted in FIG. 1B, the first polarized component PL1 (S-wave) of the light emitted from the light source is optically rotated by the first liquid crystal cell 10 and transitions to the P-wave, is optically rotated by the second liquid crystal layer LC2 of the second liquid crystal cell 20 and transitions to the S-wave, is diffused in the Y-axis direction at the second electrode E22, is optically rotated by the third liquid crystal layer LC3 and transitions to the P-wave, and is emitted. The second polarized component PL2 (P-wave) is optically rotated in the first liquid crystal layer LC1 of the first liquid crystal cell 10 to transition to the S-wave, is diffused in the Y-axis direction at the second electrode E12, is optically rotated in the second liquid crystal cell 20 to transition to the P-wave, is optically rotated in the third liquid crystal layer LC3 of the third liquid crystal cell 30 to transition to the S-wave, is diffused in the Y-axis direction at the second electrode E32, and is emitted.

Therefore, the liquid crystal light control device 100, based on the control signal application conditions shown in FIG. 1B, optically rotates the first polarized component PL1 and the second polarized component PL2, emits light that is diffused once in the Y-axis direction for the first polarized component PL1 and twice in the Y-axis direction for the second polarized component PL2, and then emits the light. That is, the liquid crystal light control device 100 can spread the light distribution state of the light emitted from the light source in the Y-axis direction. Such a light distribution pattern can be called line light distribution, as in the case of FIG. 1A.

FIG. 1C shows a state in which the control signal LH1 is applied to the first strip electrode E11A of the first liquid crystal cell 10, the control signal HL1 is applied to the second strip electrode E11B, the control signal LH1 is applied to the third strip electrode E12A and the control signal HL1 is applied to the fourth strip electrode E12B, the control signal LH1 is applied to the first strip electrode E21A of the second liquid crystal cell 20 and the control signal HL1 is applied to the second strip electrode E21B, the control signal LH1 is applied to the third strip electrode E22A, the control signal HL1 is applied to the fourth strip electrode E22B, the control signal LH1 is applied to the first strip electrode E31A of the third liquid crystal cell 30, the control signal HL1 is applied to the second strip electrode E31B, the control signal LH1 is applied to the third strip electrode E32A, and the control signal HL1 is applied to the fourth strip electrode E32B.

As shown in the table inserted in FIG. 1C, the first polarized component PL1 (S-wave) of the light emitted from the light source is optically rotated by the first liquid crystal cell 10 and transitions to the P-wave, is diffused in the X-axis direction at the first electrode E21 of the second liquid crystal cell 20, is optically rotated by the second liquid crystal layer LC2 to transition to the P-wave, is diffused in the Y-axis direction at the second electrode E22, is optically rotated by the third liquid crystal cell 30 to transition to the P-wave, and is emitted. The second polarized component PL2 (P-wave) is diffused in the X-axis direction at the first electrode E11 of the first liquid crystal cell 10, is optically rotated by the first liquid crystal cell 10 and transitions to the S-wave, is diffused in the Y-axis direction at the second electrode E12, is optically rotated in the second liquid crystal cell 20 to transition to the P-wave, is diffused in the X-axis direction at the first electrode E31 of the third liquid crystal cell 30, is optically rotated in the third liquid crystal layer LC3 to transition to the S-wave, is diffused in the Y-axis direction at the second electrode E32, and is emitted.

Therefore, the liquid crystal light control device 100 diffuses the first polarized component PL1 and the second polarized component PL2 once in each of the X-axis direction and the Y-axis direction for the first polarized component PL1, and diffuses the second polarized component PL2 twice in each of the X-axis direction and the Y-axis direction while optically rotating the first polarized component PL1 and the second polarized component PL2 in accordance with the control signal application conditions shown in FIG. 1C. That is, it is possible to spread the light distribution state of the light emitted from the light source in both the X-axis direction and the Y-axis direction by diffusing at least one of the polarized components not only in one direction but in two directions that intersect each other (in this embodiment, the X-axis direction and the Y-axis direction). Such a light distribution pattern can be called circular light distribution.

FIG. 11B shows an example of control signals different from those shown in FIG. 11A. The control signals LH1 and HL1 are the same as those described with reference to FIG. 11A. The control signal LH2 is a signal whose voltage level changes from VL2 to VH2 and from VH2 to VL2, and the control signal HL2 is a signal whose voltage level periodically changes from VH2 to VL2 and from VL2 to VH2. The low-level voltage VI2 is, for example, 0 V or −30 V, and the high-level voltage Vh2 is, for example, 60 V (relative to VI2=0 V) or 30 V (relative to VI1=−30 V). The control signal LH2 and the control signal HL2 are synchronized, and when the control signal LH2 is at the VH2 level, the control signal HL2 is at the VL2 level, and when the control signal LH2 changes to the VL2 level, the control signal HL2 changes to the VH2 level. The period of the control signals LH2 and HL2 is the same as that of the control signals LH1 and HL1.

The use of these two levels of control signals makes it possible to change the circular light distribution in FIG. 1C to an elliptical light distribution. More specifically, the control signal LH1 is applied to the first strip electrode E11A of the first liquid crystal cell 10, the control signal HL1 is applied to the second strip electrode E11B, the control signal LH2 is applied to the third strip electrode E12A, and the control signal HL2 is applied to the fourth strip electrode E12B, the control signal LH1 is applied to the first strip electrode E21A of the second liquid crystal cell 20, the control signal HL1 is applied to the second strip electrode E21B, the control signal LH2 is applied to the third strip electrode E22A, and the control signal HL2 is applied to the fourth strip electrode E22B, the control signal LH1 is applied to the first strip electrode E31A of the third liquid crystal cell 30, the control signal HL1 is applied to the second strip electrode E31B, the control signal LH2 is applied to the third strip electrode E32A, and the control signal HL2 is applied to the fourth strip electrode E32B.

Thus, an elliptical light distribution in which the light distribution state (degree of diffusion) in the X-axis direction is larger than the light distribution state (degree of diffusion) in the Y-axis direction can be formed. As described above, it is possible to form an elliptical light distribution in which the light distribution in the Y-axis direction is larger than that in the X-axis direction by swapping the control signal LH1 and the control signal LH2 and also swapping the control signal HL1 and the control signal HL2.

FIG. 1D shows an example in which the control signals of different voltage levels are applied to the first liquid crystal cell 10 and the third liquid crystal cell 30, and the second liquid crystal cell 20. That is, the control signal CV is applied to the first strip electrode E11A and the second strip electrode E11B of the first liquid crystal cell 10, the control signal LH1 is applied to the third strip electrode E12A, and the control signal HL1 is applied to the fourth strip electrode E12B, the control signal LH2 is applied to the first strip electrode E21A of the second liquid crystal cell 20, the control signal HL2 is applied to the second strip electrode E21B, the control signal CV is applied to the third strip electrode E22A and the fourth strip electrode E22B, the control signal CV is applied to the first strip electrode E31A and the second strip electrode E31B of the third liquid crystal cell 30, the control signal LH1 is applied to the third strip electrode E32A, and the control signal HL1 is applied to the fourth strip electrode E32B.

As shown in the table inserted in FIG. 1D, the first polarized component PL1 (S-wave) of the light emitted from the light source is optically rotated by the first liquid crystal cell 10 and transitions to the P-wave, is diffused in the X-axis direction at the first electrode E21 of the second liquid crystal cell 20, is optically rotated by the second liquid crystal cell 20 and transitions to the S-wave, and is optically rotated by the third liquid crystal cell 30 and transitions to the P-wave before being emitted. The second polarized component PL2 (P-wave) is optically rotated by the first liquid crystal layer LC1 of the first liquid crystal cell 10 to transition to the S-wave, is diffused in the Y-axis direction at the second electrode E12, is optically rotated by the second liquid crystal cell 20 to transition to the P-wave, is optically rotated by the third liquid crystal layer LC3 of the third liquid crystal cell 30 to transition to the S-wave, is diffused in the Y-axis direction at the second electrode E32 and is emitted.

Therefore, the liquid crystal light control device 100, according to the control signal application conditions shown in FIG. 1D, optically rotates the first polarized component PL1 and the second polarized component PL2 while diffusing the first polarized component PL1 once in the X-axis direction by the control signals LH2 and HL2 and the second polarized component PL2 twice in the Y-axis direction by the control signals LH1 and HL1, respectively, and then emits the light. That is, the liquid crystal light control device 100 can distribute the light emitted from the light source so that the first polarized component PL1 is diffused only in the X-axis direction and the second polarized component PL2 is diffused only in the Y-axis direction. In this way, it is possible to form a cross-shaped light distribution pattern by controlling each polarized component to be diffused independently of each other in a specific direction.

Since the amplitudes of the control signals LH2 and HL2 applied to the first electrode E21 of the second liquid crystal cell 20 are larger than those of the control signals LH1 and HL21, diffusion in the X-axis direction is large (spreading is large). That is, the liquid crystal light control device 100 can extend the light emitted from the light source in the X-axis direction more than in the Y-axis direction and distribute the light. In other words, it is possible to change the spread of the cross (the length in the X-axis direction and the length in the Y-axis direction) when performing cross light distribution by changing the voltage level of the control signal.

FIG. 1E shows an example of cross light distribution with control signal application conditions different from those in FIG. 1D.

FIG. 1E shows a state in which the control signal LH1 is applied to the first strip electrode E11A of the first liquid crystal cell 10, the control signal HL1 is applied to the second strip electrode E11B, and the control signal CV is applied to the third strip electrode E12A and the fourth strip electrode E12B, the control signal CV is applied to the first strip electrode E21A and the second strip electrode E21B of the second liquid crystal cell 20, the control signal LH2 is applied to the third strip electrode E22A, and the control signal HL2 is applied to the fourth strip electrode E22B, the control signal LH1 is applied to the first strip electrode E31A of the third liquid crystal cell 30, the control signal HL1 is applied to the second strip electrode E31B, and the control signal CV is applied to the third strip electrode E32A and the fourth strip electrode E32B.

As shown in the table inserted in FIG. 1E, the first polarized component PL1 (S-wave) of the light emitted from the light source is optically rotated by the first liquid crystal cell 10 and transitions to the P-wave, is optically rotated by the second liquid crystal layer LC2 of the second liquid crystal cell 20 and transitions to the S-wave, is diffused in the Y-axis direction by the second electrode E22, is optically rotated by the third liquid crystal cell 30 and transitions to the P-wave, and is then emitted. The second polarized component PL2 (P-wave) is diffused in the X-axis direction at the first electrode E11 of the first liquid crystal cell 10, is optically rotated in the first liquid crystal layer LC1 to transition to the S-wave, is optically rotated in the second liquid crystal cell 20 to transition to the P-wave, is diffused in the X-axis direction at the first electrode E31 of the third liquid crystal cell 30, is optically rotated in the third liquid crystal layer LC3 to transition to the S-wave, and is emitted.

Therefore, the liquid crystal light control device 100, according to the control signal application conditions shown in FIG. 1E, optically rotates the first polarized component PL1 and the second polarized component PL2, diffuses the first polarized component PL1 once in the Y-axis direction by the control signals LH2 and HL2, and diffuses the second polarized component PL2 twice in the X-axis direction by the control signals LH1 and HL1, and then emits the light. That is, the liquid crystal light control device 100 performs cross-polarized light distribution by spreading the light distribution state of the light emitted from the light source in the Y-axis direction for the first polarized component PL1 and in the X-axis direction for the second polarized component PL2.

FIG. 1F shows an example of cross light distribution performed under control signal application conditions different from those in FIG. 1E.

FIG. 1F shows a state in which the control signal CV is applied to the first strip electrode E11A and the second strip electrode E11B of the first liquid crystal cell 10, the control signal LH1 is applied to the third strip electrode E12A, and the control signal HL1 is applied to the fourth strip electrode E12B, the control signal LH2 is applied to the first strip electrode E21A of the second liquid crystal cell 20, the control signal HL2 is applied to the second strip electrode E21B, the control signal CV is applied to the third strip electrode E22A and the fourth strip electrode E22B, the control signal CV is applied to the first strip electrode E31A and the second strip electrode E31B of the third liquid crystal cell 30, and the control signal CV is applied to the third strip electrode E32A and the fourth strip electrode E32B.

As shown in the table inserted in FIG. 1F, the first polarized component PL1 (S-wave) of the light emitted from the light source is optically rotated by the first liquid crystal cell 10 and transitions to the P-wave, is diffused in the X-axis direction at the first electrode E21 of the second liquid crystal cell 20, is optically rotated by the second liquid crystal layer LC2 and transitions to the S-wave, and is optically rotated by the third liquid crystal cell 30 and transitions to the P-wave before being emitted. The second polarized component PL2 (P-wave) is optically rotated by the first liquid crystal layer LC1 of the first liquid crystal cell 10 to transition to the S-wave, is diffused in the Y-axis direction at the second electrode E12, is optically rotated by the second liquid crystal cell 20 to transition to the P-wave, is optically rotated by the third liquid crystal cell 30 to transition to the S-wave, and is emitted.

Therefore, the liquid crystal light control device 100, according to the control signal application conditions shown in FIG. 1F, optically rotates the first polarized component PL1 and the second polarized component PL2, the first polarized component PL1 is diffused once in the X-axis direction by the control signals LH2 and HL2, and the second polarized component PL2 is diffused once in the Y-axis direction by the control signals LH1 and HL1, and then emits the light. In this way, the cross-light distribution can be achieved by diffusing the first polarized component PL1 once in the X-axis direction and the second polarized component PL2 once in the Y-axis direction.

FIG. 1G shows an example of cross light distribution with control signal application conditions different from those in FIG. 1F.

FIG. 1G shows a state in which the control signal LH1 is applied to the first strip electrode E11A of the first liquid crystal cell 10, the control signal HL1 is applied to the second strip electrode E11B, and the control signal CV is applied to the third strip electrode E12A and the fourth strip electrode E12B, the control signal CV is applied to the first strip electrode E21A and the second strip electrode E21B of the second liquid crystal cell 20, the control signal LH2 is applied to the third strip electrode E22A, and the control signal HL2 is applied to the fourth strip electrode E22B, the control signal CV is applied to the first strip electrode E31A and the second strip electrode E31B of the third liquid crystal cell 30, and the control signal CV is applied to the third strip electrode E32A and the fourth strip electrode E32B.

As shown in the table inserted in FIG. 1G, the first polarized component PL1 (S-wave) of the light emitted from the light source is optically rotated by the first liquid crystal cell 10 and transitions to the P-wave, is optically rotated by the second liquid crystal layer LC2 of the second liquid crystal cell 20 and transitions to the S-wave, is diffused in the Y-axis direction by the second electrode E22, is optically rotated by the third liquid crystal cell 30 and transitions to the P-wave, and is then emitted. The second polarized component PL2 (P-wave) is diffused in the X-axis direction at the first electrode E11 of the first liquid crystal cell 10, is optically rotated by the first liquid crystal layer LC1 to transition to the S-wave, is optically rotated by the second liquid crystal cell 20 to transition to the P-wave, is optically rotated by the third liquid crystal cell 30 to transition to the S-wave, and is emitted.

Therefore, the liquid crystal light control device 100, based on the control signal application conditions shown in FIG. 1G, optically rotates the first polarized component PL1 and the second polarized component PL2, diffuses the first polarized component PL1 once in the Y-axis direction by the control signals LH2 and HL2, and diffuses the second polarized component PL2 once in the X-axis direction by the control signals LH1 and HL1, and then emits the light. In this way, the cross-light distribution can be achieved in the same manner even with application conditions different from the control signal application conditions shown in FIG. 1F.

Note that in FIG. 1D, FIG. 1E, FIG. 1F, and FIG. 1G, the control signals LH2 and HL2 applied to the second liquid crystal cell 20 can be replaced with the control signals LH1 and HL1 applied to the first liquid crystal cell 10 and the third liquid crystal cell 30, and cross light distribution can be achieved in the same manner.

As described above, the liquid crystal light control device 100 according to the present embodiment can change the light emitted from the light source into various light distribution states by using three liquid crystal cells. Since the liquid crystal light control device 100 according to the present embodiment is configured with three liquid crystal cells, it is possible to make it smaller and thinner. The use of the liquid crystal light control device 100 according to the present embodiment makes it possible to reduce the size of a lighting device with light distribution control.

### Second Embodiment

This embodiment shows the light distribution characteristics of the liquid crystal light control device 100 shown in the first embodiment. The cell gap and electrode pitch of the liquid crystal light control device 100 used for measurement are shown in Table 1. The control signals LH1 and HL1 for driving the liquid crystal light control device 100 are VH1=15 V and VL1=−15 V (refer to FIG. 11A), the control signal LH1 is applied to the first electrodes E11, E21, and E31 of the first liquid crystal cell 10, the second liquid crystal cell 20, and the third liquid crystal cell 30, and the control signal HL1 is applied to the second electrodes E12, E22, and E32. The electrode width of the strip electrodes that constitute the first and second electrodes is 8 μm, and the electrode pitch is also 8 μm.

TABLE 1

| | Cell Gap | Width/Spacing of Electrode |
|---|---|---|
| 1st liquid crystal cell (10) | 30 μm | 8 μm/8 μm |
| 2nd liquid crystal cell (20) | | |
| 3rd liquid crystal cell (30) | | |

| | |
|---|---|
| Light Distribution Angle | 51 degrees |

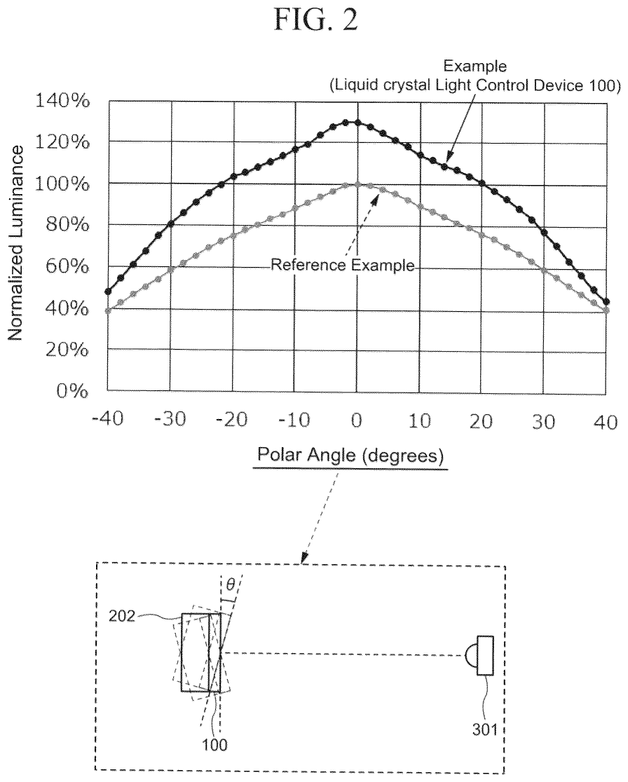

FIG. 2 shows the brightness-angle characteristics of the liquid crystal light control device 100. The horizontal axis of the graph shown in FIG. 2 indicates the polar angle, and the vertical axis indicates the normalized brightness. The graph shown in FIG. 2 shows the characteristics of the liquid crystal light control device 100 and, as a reference example, the characteristics of a liquid crystal light control device configured with four liquid crystal cells.

The “polar angle” refers to the angle between the normal direction of the principal plane of the liquid crystal light control device and the direction of propagation of the emitted light. As shown in the inset of FIG. 2, the measurement is performed while rotating the liquid crystal light control device 100 and the light source 202 relative to the detector 301. As shown in the figure, the angle θ by which the principal plane of the liquid crystal light control device 100 is tilted relative to the state in which the principal plane of the liquid crystal light control device 100 is facing the detector 301 (the state in which the detector 301 is arranged in the normal direction of the principal plane of the liquid crystal light control device 100) corresponds to the polar angle.

As shown in the graph in FIG. 2, the liquid crystal light control device 100 has higher overall brightness than the reference example device (a device with four liquid crystal cells). The liquid crystal light control device 100 has a light distribution angle of 51 degrees, which is comparable to the light distribution angle of 54 degrees of the reference example device (a device with four liquid crystal cells). The light distribution angle is the angle (polar angle) at which the brightness is ½ of the brightness when the polar angle is 0 degrees.

The light distribution angle is the angle at which the brightness is ½ of the brightness when the polar angle is 0 degrees.

As shown in the graph in FIG. 2, it is possible to increase the brightness and maintain a wide light distribution angle by using a configuration with three liquid crystal cells. Furthermore, by using such a liquid crystal light control device, it is possible to reduce the amount of liquid crystal used and miniaturize the lighting device without deteriorating the light distribution characteristics.

### Third Embodiment

This embodiment shows the light distribution characteristics when the cell gap of the liquid crystal cell is changed in the liquid crystal light control device 100 shown in the first embodiment. The cell gaps of the liquid crystal light control device 100 used for measurement are shown in Table 2, the cell gaps of the first liquid crystal cell 10 and the third liquid crystal cell 30 are 30 μm, while the cell gap of the second liquid crystal cell 20 is 55 μm. That is, the cell gap D2 of the second liquid crystal cell 20 is larger than the cell gap D1 of the first liquid crystal cell 10 and the third liquid crystal cell 30 (D2>D1). In this embodiment, D2 is 1.5×D1, but it is sufficient that D2 is at least D1. On the other hand, since there is a natural limit to the cell gap in order to stably control the liquid crystal molecules, it is desirable that D2 be 100 μm or less, and in light of this, it is more desirable that D2 be 4×D1 or less. The drive conditions of the liquid crystal light control device 100 are the same as in the second embodiment.

TABLE 2

| | Cell Gap | Width/Spacing of Electrode |
|---|---|---|
| 1st liquid crystal cell (10) | 30 μm | 8 μm/8 μm |
| 2nd liquid crystal cell (20) | 55 μm | |
| 3rd liquid crystal cell (30) | 30 μm | |

| | |
|---|---|
| Light Distribution Angle | 54 degrees |

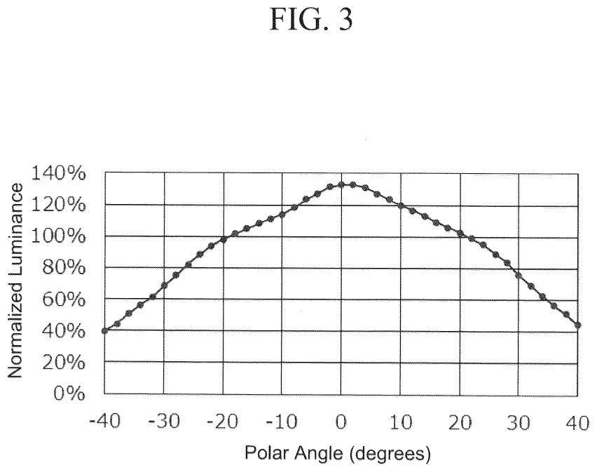

FIG. 3 shows the brightness-angle characteristics of the liquid crystal light control device 100 having the structure shown in Table 2. As shown in the graph in FIG. 3, the liquid crystal light control device 100 has no significant change in brightness when the polar angle is 0 degrees, and the light distribution angle is 54 degrees.

As shown in the present embodiment, the light distribution characteristics can be improved by enlarging the cell gap of the central liquid crystal cell among the three cells. As in the second embodiment, the configuration of the liquid crystal light control device 100 according to the present embodiment has one less liquid crystal cell than the device in the reference example (a device with four liquid crystal cells), thereby reducing the amount of liquid crystal used and enabling miniaturization of the lighting device without deteriorating the light distribution characteristics.

### Fourth Embodiment

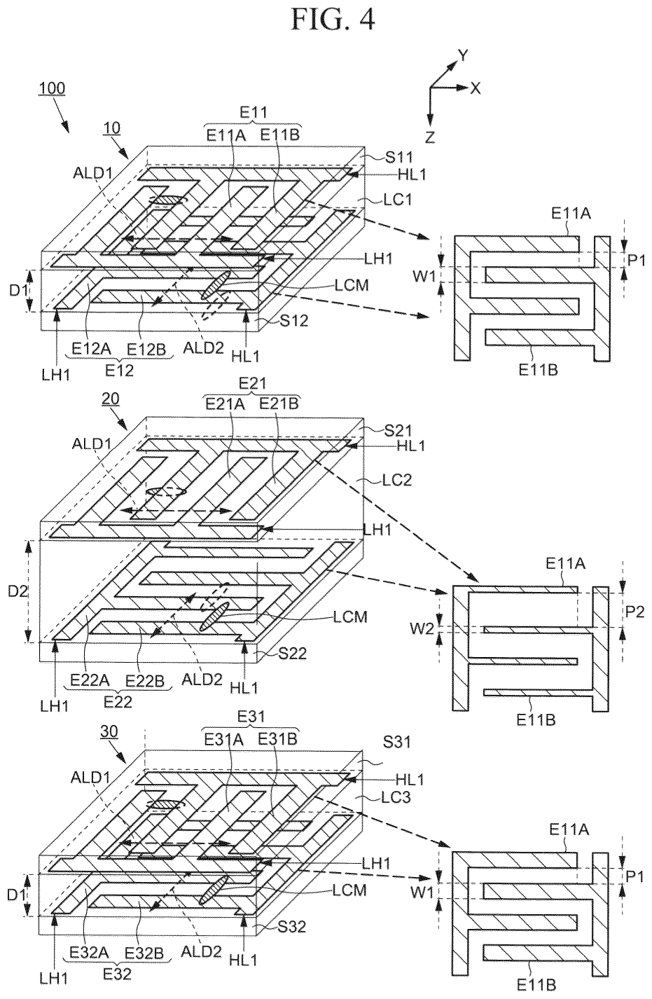

This embodiment shows the light distribution characteristics when the electrode width and electrode pitch of the liquid crystal cell are changed in the liquid crystal light control device 100 shown in the first embodiment. FIG. 4 shows the configuration of the liquid crystal light control device 100 used for evaluation. The liquid crystal light control device 100 shown in FIG. 4 is such that the cell gap D2 of the second liquid crystal cell 20 is larger than the cell gap D1 of the first liquid crystal cell 10 and the third liquid crystal cell 30 (D1<D2). The relationship between the electrode width W1 and the electrode spacing P1 of the first liquid crystal cell 10 and the third liquid crystal cell 30 and the electrode width W2 and the electrode spacing P2 of the second liquid crystal cell 20 is such that W1>W2 and P1<P2. The relationship between the cell gap D1 of the first liquid crystal cell 10 and the third liquid crystal cell 30 and the electrode width W1 and the electrode pitch P1 is designed such that the value of W1+P1 is approximately ½ of D1. Similarly, the relationship between the cell gap D2 of the second liquid crystal cell 20 and the electrode width W2 and electrode spacing P2 is designed so that the value of W2+P2 is approximately ½ of D2. As a specific example, as shown in Table 3, the cell gap of the first liquid crystal cell 10 and the third liquid crystal cell 30 is 30 μm, while the electrode width/electrode spacing is 8 μm/8 μm, and the cell gap of the second liquid crystal cell 20 is 55 μm, while the electrode width/electrode spacing is 4 μm/24 μm.

TABLE 3

| | Cell Gap | Width/Spacing of Electrode |
|---|---|---|
| 1st liquid crystal cell (10) | 30 μm | 4 μm/8 μm |
| 2nd liquid crystal cell (20) | 55 μm | 4 μm/24 μm |
| 3rd liquid crystal cell (30) | 30 μm | 8 μm/8 μm |

| | |
|---|---|
| Light Distribution Angle | 54 degrees |

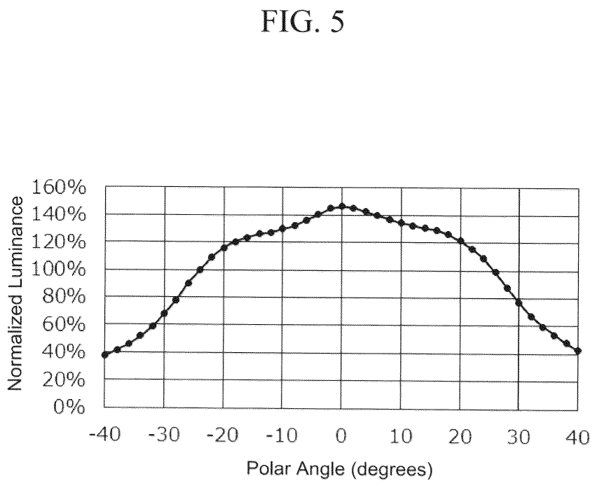

FIG. 5 shows the brightness-angle characteristics of the liquid crystal light control device 100 having the structure shown in Table 3. As shown in the graph in FIG. 5, the characteristics of the liquid crystal light control device 100 according to the present embodiment have higher brightness than the characteristics shown in the third embodiment (FIG. 3), and it can be seen that the region where the brightness change is small (the flat curve in the graph) is expanded in the region where the polar angle is small. The light distribution angle is 53 degrees, and the same results as those obtained with the liquid crystal light control device in the third embodiment are obtained.

As shown in this embodiment, the light distribution characteristics can be changed by changing the electrode width and electrode spacing of the liquid crystal cell. In particular, it is possible to expand the region of high brightness and uniformity by narrowing the electrode width and widening the electrode spacing of a liquid crystal cell with a large cell gap.

The various configurations of the liquid crystal light control device illustrated as an embodiment of the present invention may be combined as appropriate as long as they are not mutually contradictory. Based on the liquid crystal light control device disclosed in this specification and the drawings, the scope of the present invention includes those in which a person skilled in the art adds, deletes, or redesigns components as appropriate, or adds, omits, or changes conditions of processes, as long as they embody the essence of the present invention.

It should be understood that other advantageous effects, even if different from those described in the present specification, which are apparent from the description of the present specification or can be easily predicted by those skilled in the art, are also provided by the present invention.

What is claimed is:

1. A liquid crystal light control device comprising:
a first liquid crystal cell;
a second liquid crystal cell; and
a third liquid crystal cell,
each of the first liquid crystal cell, the second liquid crystal cell, and the third liquid crystal cell comprising:
a first substrate arranged on a light incident side;
a second substrate arranged on a light emission side; and
a liquid crystal layer between the first substrate and the second substrate,
the first liquid crystal cell, the second liquid crystal cell, and the third liquid crystal cell are arranged overlapping each other in the direction of light emission from a light source,
each of the first liquid crystal cell, the second liquid crystal cell, and the third liquid crystal cell includes:
a first electrode comprising a first strip electrode and a second strip electrode arranged on the first substrate; and
a second electrode comprising a third strip electrode and a fourth strip electrode arranged on the second substrate,
wherein
the first stripe electrode and second stripe electrode extend in a direction intersecting with the direction of the third stripe electrode and fourth stripe electrode,
the first stripe electrode and the second stripe electrode of the first liquid crystal cell, the first stripe electrode and the second stripe electrode of the second liquid crystal cell, and the first stripe electrode and the second stripe electrode of the third liquid crystal cell extend in the same direction, and
the third stripe electrode and the fourth stripe electrode of the first liquid crystal cell, the third stripe electrode and the fourth stripe electrode of the second liquid crystal cell, and the third stripe electrode and the fourth stripe electrode of the third liquid crystal cell extend in the same direction.

2. The liquid crystal light control device according to claim 1, wherein a gap between the first substrate and the second substrate of the second liquid crystal cell is larger than a gap between the first substrate and the second substrate of the first liquid crystal cell and a gap between the first substrate and the second substrate of the third liquid crystal cell.

3. The liquid crystal light control device according to claim 2, wherein a spacing between the first strip electrode and the second strip electrode of the first liquid crystal cell and a spacing between the first strip electrode and the second strip electrode of the third liquid crystal cell are larger than a spacing between the first strip electrode and the second strip electrode and a spacing between the third strip electrode and the fourth strip electrode of the second liquid crystal cell.

4. The liquid crystal light control device according to claim 1, wherein each of the first liquid crystal cell, the second liquid crystal cell, and the third liquid crystal cell includes a first alignment film and a second alignment film,
wherein the first alignment film is arranged on the first substrate, and the second alignment film is arranged on the second substrate, and
wherein an alignment direction of the first alignment film intersects an alignment direction of the second alignment film.

5. The liquid crystal light control device according to claim 1, wherein the liquid crystal layer is a twisted nematic (TN) liquid crystal.

6. A lighting device comprising:
a liquid crystal light control device including a first liquid crystal cell, a second liquid crystal cell, and a third liquid crystal cell; and
a light source,
each of the first liquid crystal cell, the second liquid crystal cell, and the third liquid crystal cell comprising:
a first substrate arranged on a light incident side;
a second substrate arranged on a light emission side; and
a liquid crystal layer between the first substrate and the second substrate,
the first liquid crystal cell, the second liquid crystal cell, and the third liquid crystal cell are arranged overlapping each other in the direction of light emission from the light source,
each of the first liquid crystal cell, the second liquid crystal cell, and the third liquid crystal cell includes:
a first electrode comprising a first strip electrode and a second strip electrode arranged on the first substrate; and
a second electrode comprising a third strip electrode and a fourth strip electrode arranged on the second substrate,
wherein
the first stripe electrode and second stripe electrode extend in a direction intersecting with the direction of the third stripe electrode and fourth stripe electrode,
the first stripe electrode and the second stripe electrode of the first liquid crystal cell, the first stripe electrode and the second stripe electrode of the second liquid crystal cell, and the first stripe electrode and the second stripe electrode of the third liquid crystal cell extend in the same direction, and
the direction in which the third strip electrode and the fourth strip electrode of the first liquid crystal cell extend, the direction in which the third strip electrode and the fourth strip electrode of the second liquid crystal cell extend, and the direction in which the third strip electrode and the fourth strip electrode of the third liquid crystal cell extend are the same,
the third stripe electrode and the fourth stripe electrode of the first liquid crystal cell, the third stripe electrode and the fourth stripe electrode of the second liquid crystal cell, and the third stripe electrode and the fourth stripe electrode of the third liquid crystal cell extend in the same direction.

7. The lighting device according to claim 6, wherein a gap between the first substrate and the second substrate of the second liquid crystal cell is larger than a gap between the first substrate and the second substrate of the first liquid crystal cell and a gap between the first substrate and the second substrate of the third liquid crystal cell.

8. The lighting device according to claim 7, wherein a spacing between the first strip electrode and the second strip electrode of the first liquid crystal cell and a spacing between the first strip electrode and the second strip electrode of the third liquid crystal cell are larger than a spacing between the first strip electrode and the second strip electrode and a spacing between the third strip electrode and the fourth strip electrode of the second liquid crystal cell.

9. The lighting device according to claim 6, wherein each of the first liquid crystal cell, the second liquid crystal cell, and the third liquid crystal cell includes a first alignment film and a second alignment film,
wherein the first alignment film is arranged on the first substrate, and the second alignment film is arranged on the second substrate, and
wherein an alignment direction of the first alignment film intersects an alignment direction of the second alignment film.

10. The lighting device according to claim 6, wherein the liquid crystal layer is a twisted nematic (TN) liquid crystal.
